(19) United States
(12) Patent Application Publication
(10) Pub. No.: US 2002/0076544 A1
(43) Pub. Date: Jun. 20, 2002

(54) Laminate composite wall coverings and method for making such

(76) Inventors: Samuel W. DeWorth, Pickerington, OH (US); Arthur F. Korney JR., Pickerington, OH (US); Burch E. Zehner, Gahanna, OH (US)

Correspondence Address: STANDLEY & GILCREST LLP, 495 METRO PLACE SOUTH, SUITE 210, DUBLIN, OH, 43017, US

(21) Appl. No.: 09/737,144

(22) Filed: Dec. 14, 2000

(51) Int. Cl. B32B 7/12

(52) U.S. Cl. 428/317.1; 428/317.3; 428/317.9; 428/355 BL; 156/244.11

(57) ABSTRACT

The present invention includes a method for forming laminate composite wall coverings that minimize or eliminate failure causing voids, and laminate composite wall coverings formed thereby. One side of an extrudate preferably has an application zone which is substantially coated with an adhesive. A second material, referred to as a backing layer, is also preferably coated substantially or completely on one side with an adhesive. The coated surfaces of each of the extrudate and backing layer are then brought together under pressure to form a laminate composite wall covering. Preferably, the adhesive selected provides substantially instantaneous adhesion between the extrudate and the backing layer so that the laminate composite wall covering may be handled virtually immediately after joining of the components. The surfaces may include a predetermined curvature.

### BACKGROUND AND SUMMARY OF THE INVENTION

The present invention relates generally to laminate materials, and more particularly, to a method for making laminate construction materials. Such laminate construction materials may include, for example, extruded siding having a structural foam bonded to the inside surface thereof via a neoprene adhesive, internal wall paneling, internal wall coverings, and exterior wall coverings.

Historically, pressure sensitive adhesives (PSA's) or polyurethanes have been employed to adhere the layers of laminate construction materials to one another. However, because of the manner in which the adhesive was applied, field failures were common. The manner of application would only allow for approximately a 40% coverage of the respective application zones. Any areas within the application zones not receiving adhesive are referred to as voids. Over time, exposure to temperature variation, the elements, and ultraviolet rays would degrade the laminate. The degradation of the laminate often resulted in delamination of the extrudate from the backing layer, and/or the warping of the extrudate. The degradation of the laminate is referred to as a field failure.

The method of heating and applying PSA's is limiting in that it is difficult to apply a desirably thin layer with sufficient uniformity, and the more adhesive material required per given application area, the greater the manufacturing cost becomes. Additionally, in order to prevent delamination, the PSA's are also limited in low shock and impact resistance. Therefore, there is a need for a method of forming laminate materials that eliminates the voids that may lead to field failures.

The present invention satisfies this need. The present invention includes a method for forming laminate composite wall coverings that prevents failure causing voids, and also composite wall coverings formed thereby. In the method of the present invention, an extrudate is preferably passed to an adhesive application system where an adhesive is preferably applied to an application zone on the extrudate. A second material, referred to as a backing layer, may also receive an adhesive coating prior to being applied to the back of the extrudate. The extrudate and backing layer forming the laminate composite wall covering are preferably joined under pressure to promote maximum adhesion between the extrudate and the backing layer. Alternatively to the above method, the adhesive may be applied only to an application zone on the extrudate, or only to an application zone on the backing layer prior to the components being placed into contact.

It has been found that a neoprene adhesive, such as a neoprene latex, is especially effective for bonding the extrudate to the backing layer. When applied by spraying, the neoprene adhesive provides uniform coverage at a thickness of less than half that required by a typical PSA. It has also been found that the bonding provided by the neoprene adhesive is improved when the application zones on both the extrudate and the backing layer are coated before the components are placed into contact. Laminate composite wall coverings assembled in this manner have exhibited superior adhesion properties when subjected to testing that causes delamination to laminate composite wall coverings assembled using a typical PSA.

Thus, the present invention provides for a method of producing a laminate composite wall panel having strength superior to that of known panels of similar construction. The present invention further allows such a panel to be constructed using less actual adhesive than a previously constructed panel having inferior strength.

### BRIEF DESCRIPTION OF THE DRAWINGS

FIG. 1 is a flowchart showing the steps for forming a laminate in accordance with one embodiment of the present invention;

FIG. 2 is a diagram showing the components of a laminate formed in accordance with one embodiment of the present invention;

FIG. 3 is a diagram showing the composition of a laminate formed in accordance with one embodiment of the present invention;

FIG. 4 is a diagram showing the composition of a laminate formed in accordance with one embodiment of the present invention; and

FIG. 5 is a lateral cross-section of a laminate composite wall panel of the present invention, illustrating a curvature which may be imparted to an extrudate portion thereof.

### DETAILED DESCRIPTION OF THE EXEMPLARY EMBODIMENT(S)

The present invention relates generally to laminate materials, and more particularly, to a method for making laminate construction materials. Such laminate construction materials may include extruded siding having a structural foam backing bonded thereto via an adhesive, internal wall paneling, internal wall coverings, and exterior wall coverings.

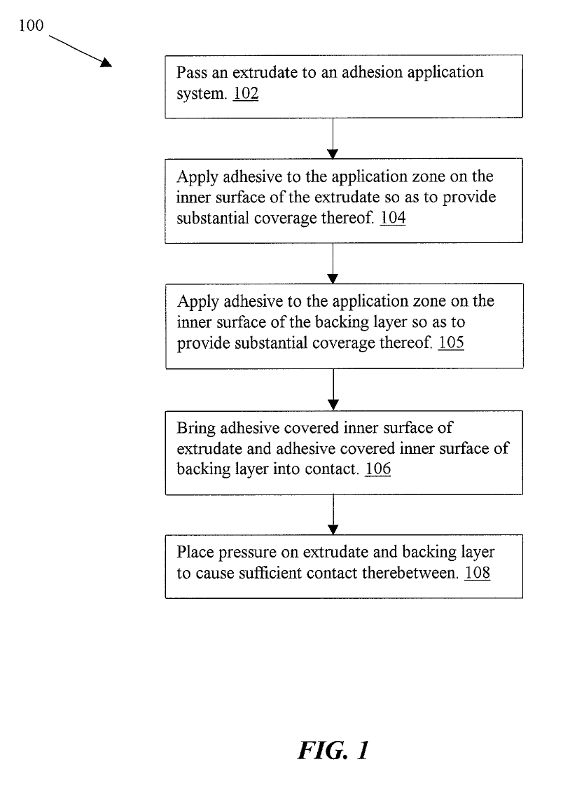

Referring to FIG. 1, a preferred method 100 for forming a composite wall covering of the present invention is shown. The extrudate is first preferably passed to an adhesion application system 102, where an adhesive is applied to an application zone on the inner surface of the extrudate 104. The adhesive is preferably applied onto the inside surface of the extrudate so as to provide substantial coverage of the application zone. A backing layer, designed to communicate with the inside surface of the extrudate, is then similarly prepared by applying a coating of the adhesive thereto 105. The adhesive coated surfaces of each of the extrudate and the backing material are then brought into contact 106, preferably under pressure 108, to form a finished laminate composite wall covering.

The inner surface of the extrudate that is intended to mate with the backing layer, or that is substantially adjacent to the backing layer, is referred to as the application zone. The application zone is preferably designed to assist in maximizing the ability of the applied adhesive to bond the extrudate to the backing material. The adhesive may be applied by any conventional technique capable of sufficiently and substantially covering the application zone of each of the extrudate and backing layer. For example, the adhesive may be applied by rollers, brushes, or sponges, but most preferably, the adhesive is applied by spraying from at least one spray nozzle.

If necessary, the curing of the assembled laminate composite wall covering may involve a single step or several steps. However, it is preferable that the adhesive used be formulated to eliminate the curing step.

Although any adhesive capable of sufficiently bonding the material of the extrudate to the material of the backing layer may be used, preferably the adhesive employed is a neoprene adhesive. As discussed above, neoprene adhesive has given excellent results when used for this purpose. Neoprene adhesive allows for a highly uniform coating to be applied to the extrudate and backing layer at a thickness of approximately half of that which would be required using a typical PSA material especially when applied by spraying. Neoprene adhesive also provides for superior bonding over known PSA materials even at these substantially reduced film thicknesses. For example, a laminate composite wall covering formed by bonding with a neoprene adhesive was subjected to a 90° pendulum impact test at a temperature of approximately 20° F. The pendulum damaged both the extrudate and the backing material, but no delamination occurred. In contrast, when a like constructed laminate composite wall w panel bonded with a PSA was subjected to the same test, the extrudate was completely separated from the backing layer.

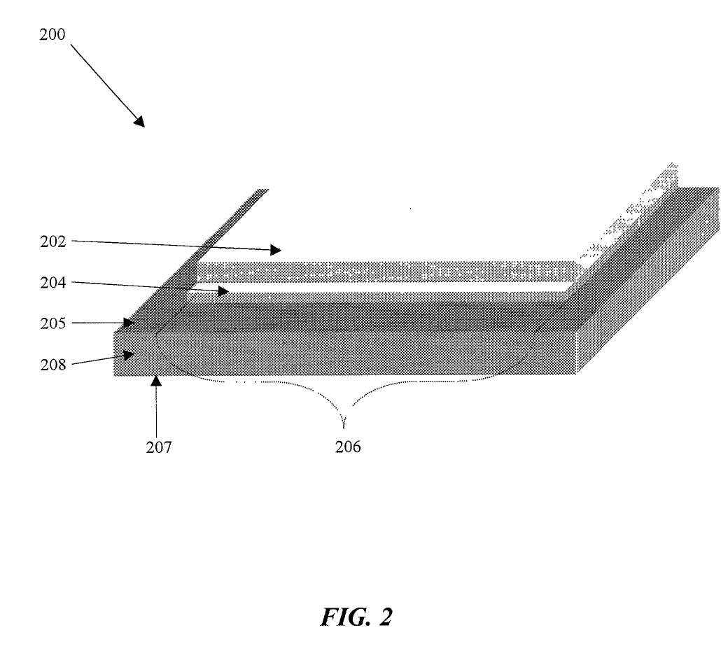

Referring now to FIG. 2, an exemplary embodiment of a laminate composite wall covering 200 of the present invention is shown to be comprised of an extruded siding 208 having an outer surface 207 and an inner surface 205. The inner surface 205 of the extruded siding 208 is adhered to a backing layer 202 by a neoprene adhesive 204 applied to an application zone 206 on each of the extruded siding 208 and backing layer 202. Although other widths are possible, in this particular embodiment of the present invention, the backing layer 202 is of the same width as the application zone 206.

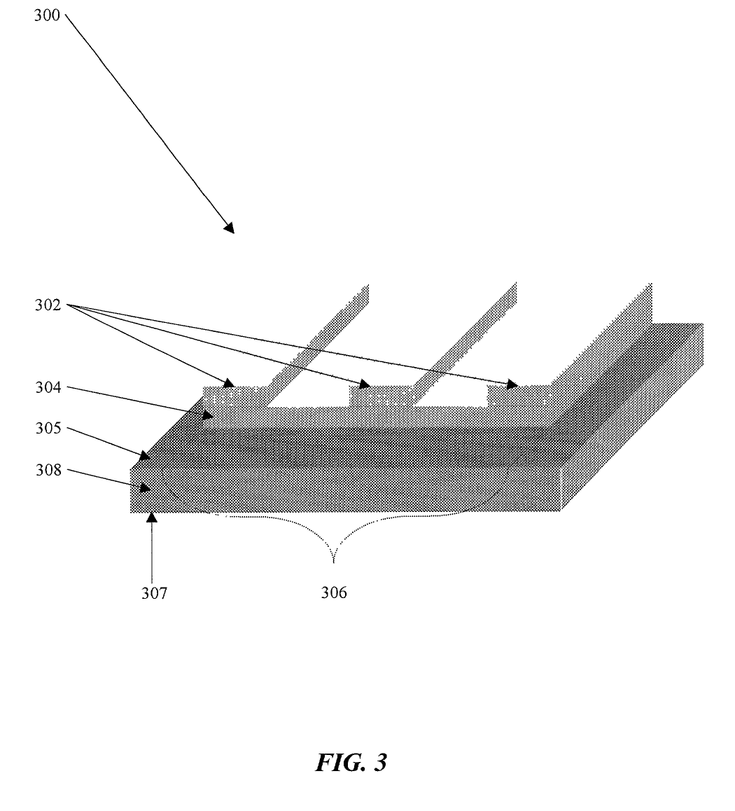

Referring to FIG. 3, an alternate embodiment of a laminate composite wall covering 300 of the present invention is comprised of an extruded siding 308 having an outer surface 307 and an inner surface 305. The inner surface 305 is adhered to backing layer strips 302 by a neoprene adhesive 304 applied to an application zone 306. In this embodiment of the present invention, the backing layer strips 302 do not cover the entire application zone 306 located on the extruded siding 308 where neoprene adhesive 304 has been deposited. However, this embodiment does not depart from the spirit of the present invention because substantially all of the mating areas of the backing layer strips 302 and the application zone 306 are covered by the neoprene adhesive 304.

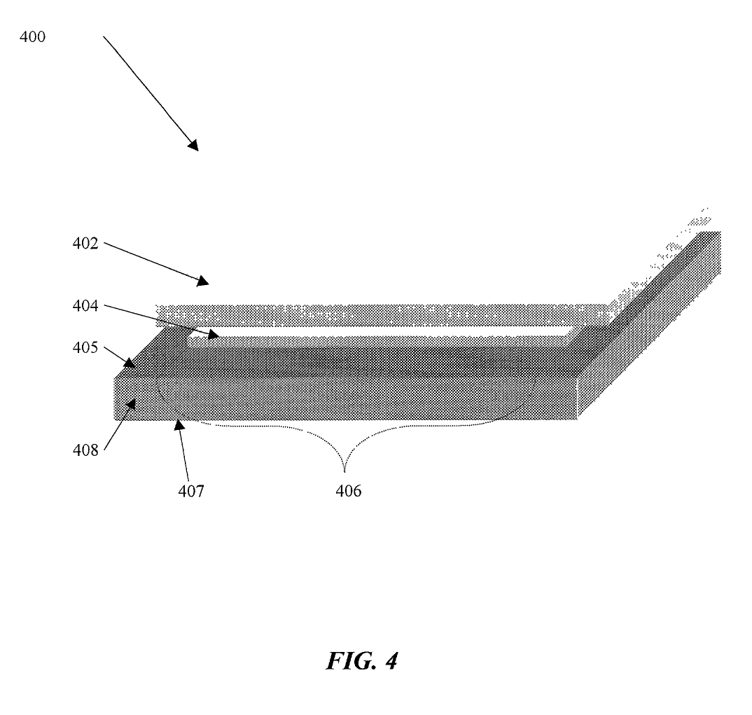

Referring to FIG. 4, another embodiment of a laminate composite wall covering 400 of the present invention may be seen, wherein an extruded siding 408 having an outer surface 407 and an inner surface 405 is adhered to a backing layer 402 by a neoprene adhesive 404 applied to an application zone 406. In this embodiment of the present invention the backing layer 402 is wider than the application zone 406. However, this embodiment does not depart from the spirit of the present invention because the neoprene adhesive 404 covers substantially all of the mating areas of the backing layer 402 and the application zone 406. The portions of the backing layer 402 not in contact with the neoprene adhesive 404 may preferably be designed to interlock with adjacent applications of composite wall coverings 400.

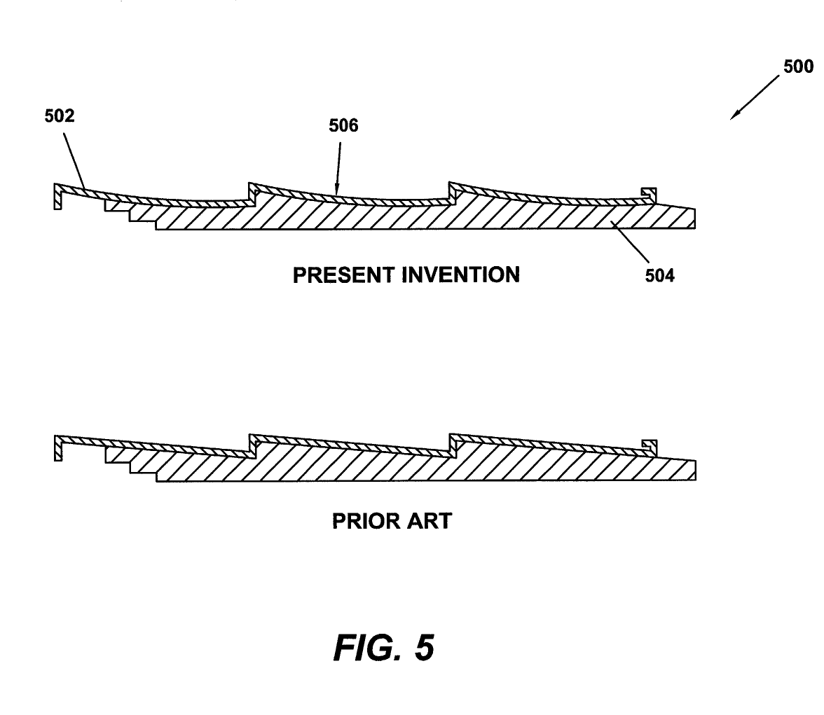

As depicted in FIG. 5, it has also been discovered that a laminate composite wall covering 500 produced by this method may benefit from a slight curvature of the extrudate 502. When laminate wall coverings so produced are employed, for example, as exterior siding, sections are generally provided on each panel to mask the joining lines formed by the abutment of adjacent panels and thereby improve the aesthetic appearance of the installation. To provide for the overlap, no backing material 504 may be bonded to the extrudate in these sections. It has been found that by providing the extrudate with a slight curvature 506, seam separation, such as may occur due to expansion and contraction may be reduced. Providing a slight curvature 506 to the extrudate 502 also appears to reduce the bowing and bulging of such siding often referred to as “oil canning”. In order to provide the curvature 506 to the extrudate 502 while maintaining an adequate amount of adhesion between the extrudate and the backing material 504, it has been found that it is preferable that the backing material exhibit substantially the same curvature as the extrudate. It is believed to be unique to apply a backing layer with curvature to a vinyl siding panel having the same mating curvature. In this manner, the likelihood of delamination of the composite 500 may be minimized.

The exemplary embodiments herein disclosed are not intended to be exhaustive or to unnecessarily limit the scope of the invention. The preferred embodiments were chosen and described in order to explain the principles of the present invention so that others skilled in the art may practice the invention. Having shown and described exemplary embodiments of the present invention, it will be within the ability of one of ordinary skill in the art to make alterations or modifications to the present invention, such as through substitution of equivalent materials or structural arrangements, or through the use of equivalent process steps, so as to be able to practice the present invention without departing from its spirit as reflected in the appended claims, the text and teaching of which are incorporated by reference herein. It is the intention, therefore, to limit the invention only as indicated by the scope of the claims and equivalents thereof

What is claimed is:

1. A method for forming a laminate composite wall covering, said method comprising the steps of:
applying an adhesive to an application zone located on an inner surface of said extrudate, said adhesive applied so as to substantially cover said application zone;
applying an adhesive to an application zone located on an inner surface of a backing layer; said adhesive applied so as to substantially cover said application zone and
placing the adhesive coated surface of said extrudate in contact with the adhesive coated surface of said backing layer and applying pressure, thereby forming a laminate;
wherein substantially immediate adhesion will occur, said adhesion of sufficient strength to allow transport of said laminate.

2. The method according to claim 1, wherein said adhesive is applied by a technique chosen from the group consisting of spraying, sponging, rolling, and brushing.

3. The method according to claim 1, wherein said extrudate is chosen from the group consisting of siding and paneling.

4. The method according to claim 1, wherein said adhesive is neoprene adhesive.

5. The method according to claim 1, wherein said backing layer is chosen from the group consisting of styrofoam, structural foam, insulating foam, and foam strips.

6. A laminate composite wall covering, said laminate composite wall covering comprising:
an extrudate, said extrudate having an outer surface and an inner surface, said
inner surface further having an application zone, said application zone having a width;
a backing layer, said backing layer having an outer surface and an inner surface, said inner surface further having an application zone; and
an adhesive, said adhesive applied to at least one of said application zones so as to substantially cover said application zone;
wherein said inner surface of said extrudate and said inner surface of said backing layer are bonded together by said adhesive existing therebetween.

7. The laminate composite wall covering of claim 6, wherein said extrudate is chosen from the group consisting of siding and paneling.

8. The laminate composite wall covering of claim 6, wherein said adhesive is neoprene adhesive.

9. The laminate composite wall covering of claim 6, wherein said neoprene adhesive is coated on the inner surface of each of said extrudate and said backing material before said extrudate and said backing material are placed into contact.

10. The laminate composite wall covering of claim 6, wherein said backing layer is chosen from the group consisting of styrofoam, structural foam, insulating foam, and foam strips.

11. The laminate composite wall covering of claim 6, wherein said adhesive is coated on said application zone so as to provide substantial coverage of said application zone.

12. A laminate composite wall covering, said laminate composite wall covering comprising:
an extrudate, said extrudate having an outer surface and an inner surface, said inner surface having an application zone substantially coated with a bonding agent, and said extrudate having a predetermined curvature; and
a backing layer, said backing layer having an outer surface and an inner surface, said inner surface having an application zone substantially coated with said bonding agent, and said backing layer having said predetermined curvature;
wherein said inner surface of said extrudate and said inner surface of said backing material are in mating contact and are bonded together by said bonding agent throughout said curvature.
